(19) United States
(12) Patent Application Publication
(10) Pub. No.: US 2008/0209140 A1
(43) Pub. Date: Aug. 28, 2008

(54) Method for Managing Memories of Digital Computing Devices

(75) Inventor: Michael Roth, Riemerling (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ROHDE & SCHWARZ GMBH & CO. KG, München (DE)

(21) Appl. No.: 11/916,805

(22) PCT Filed: Apr. 12, 2006
(86) PCT No.: PCT/EP2006/003393

§ 371 Date: Apr. 7, 2008

(30) Foreign Application Priority Data
Jun. 9, 2005 (DE) 10 2005 026 721.1

(51) Int. Cl. G06F 12/00

(52) U.S. Cl. 711/154; 711/E12.001

(57) ABSTRACT

The invention relates to a method for managing memories. When carrying out a process, at least one stack (6, 7, 8, 9) is created for memory objects (10.1, 10.2, . . . 10.k). A request for a memory object (10.k) from a stack (6, 7, 8, 9) is carried out by using an atomic operation, and a return of a memory object (10.k) to the stack (6, 7, 8, 9) is likewise carried out by using an atomic operation.

The invention relates to a method for memory management in digital computer devices.

On the basis of their large available memory and outstanding computational performance, modern computer devices support the use of complex programs. In the computer devices, such programs can perform procedures, in which several so-called threads are processed at the same time. Since many of these threads are not directly time matched relative to one another, it can occur that several threads attempt to gain access to the memory management, and therefore potentially to a given block of available memory, at the same time. Simultaneous access of this kind can lead to system instability. However, a simultaneous access to a given memory block can be prevented by an intervention of the operating system. Preventing access to a memory block, which has already been accessed, by means of a further thread has been described in DE 679 15 532 T2. In this context, a simultaneous access is prevented only if the simultaneous access relates to the same memory block.

In currently-available memory management systems, so-called doubly-linked lists are often used, for example, for managing the overall memory volume within individual memory objects. With these doubly-linked lists, access to a given memory object is gained in several stages. Accordingly, at the first access to a memory object of this kind, it is necessary to block the other threads, so that simultaneous access by another thread is not possible, before the individual stages of the first access have been processed. This access blocking is implemented by means of the operating system through a so-called mutex routine. However, incorporating the operating system and executing the mutex routine wastes valuable computing time. During this time, the other threads are blocked by the mutex-based locking through the operating system, which temporarily prevents their execution.

The object of the invention is to provide a method for memory management of a digital computer unit, which prevents the simultaneous access by subsidiary threads to a given memory block within a multi-thread environment, but which, at the same time, allows short memory-access times.

This object is achieved by the method according to the invention as specified in claim 1.

According to the invention, stack management is used for the available memory instead of doubly-linked lists. For this purpose, at least one such stack is initially created in the available memory range. The retrieval and return of a memory object by a thread is then implemented in each case by an atomic operation. Using an atomic operation of this kind for memory access together with a stack organisation of the memory, which allows only one access to the last object in the stack, makes any more extensive blocking of the other threads unnecessary. In this context, the atomic operation already guarantees that the access to the memory object is implemented in only a single stage, so that an overlap with parallel-running stages of further threads cannot occur.

Advantageous further developments of the method according to the invention are specified in the dependent claims.

One preferred exemplary embodiment is presented in the drawings and explained in greater detail below. The drawings are as follows:

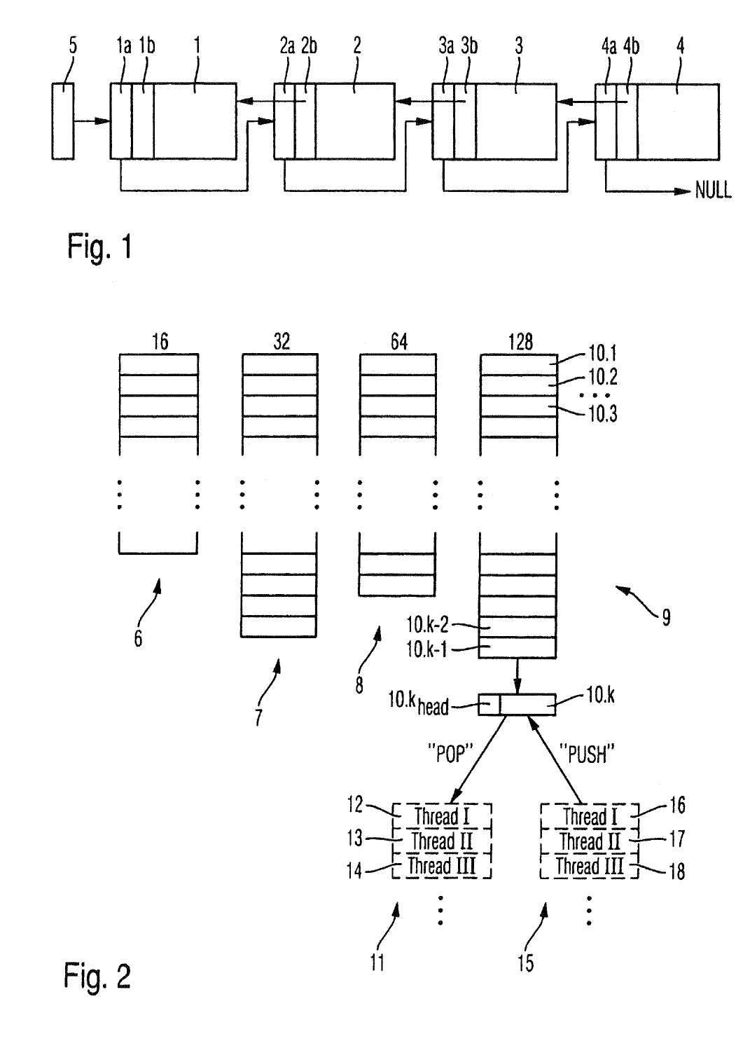

FIG. 1 shows a schematic presentation of a known memory management with doubly-linked lists;

FIG. 2 shows a memory management by means of stacking and atomic retrieval and return functions; and

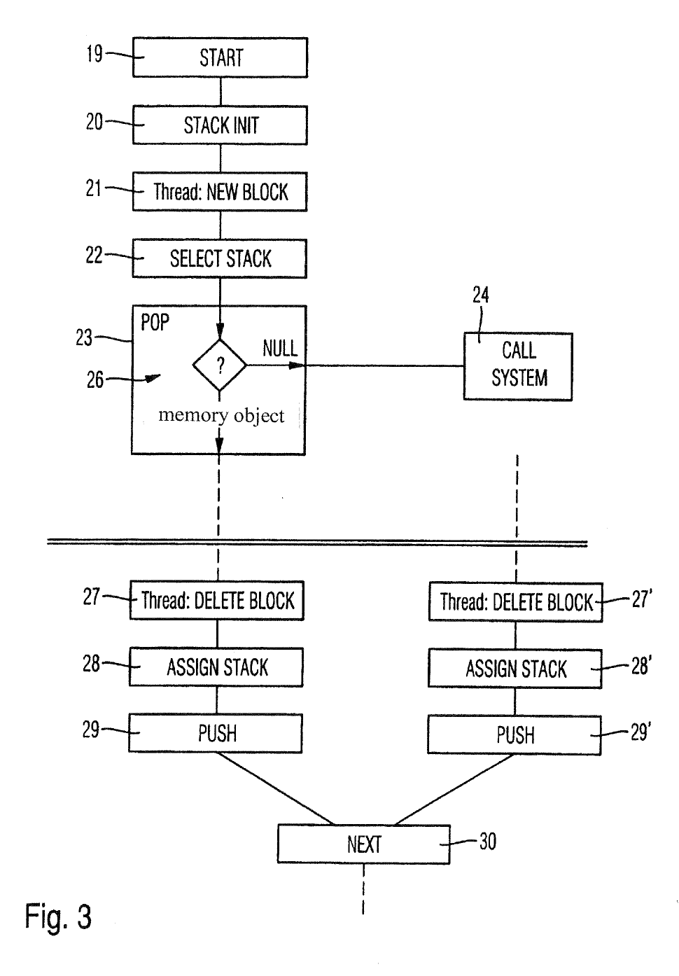

FIG. 3 shows a schematic presentation of the procedural stages of the memory management according to the invention.

In the case of so-called doubly-linked lists, the memory is subdivided into several memory objects 1, 2, 3 and 4, which are illustrated schematically in FIG. 1. A first field 1a and a second field 1b are created respectively within each such memory object 1 to 4. In this context, the first field 1a of the first memory object 1 refers to the position of the second memory object 2. Similarly, the first field 2a of the second memory object 2 refers to the position of the third memory object 3 and so on. In order to allow the retrieval of any required central block, not only is the position of the respectively next memory object in the forward direction indicated, but the position of the respectively preceding memory object 1, 2 and 3 is indicated in the second field 2b, 3b and 4b of the memory objects 2, 3 and 4. In this manner, it is possible to remove a memory object disposed between two memory objects, and at the same time to update the fields of the adjacent memory objects.

Doubly-linked lists of this kind do in fact allow the individual access to any required memory object; conversely, however, they provide the disadvantage that, in a multi-thread environment, the simultaneous access of several threads to one memory object can only be prevented via slow operations. One possibility is to manage accesses via the mutex function, as already described in the introduction. The first memory object 1 in a list can be reached via a special pointer 5 and is also characterised in that a zero vector is stored in the second field 1b instead of the position of a preceding memory object. Accordingly, the memory object 4 is characterised last by storing a zero vector in the first field 4a of the memory object 4 instead of the position of a further memory object.

By contrast, FIG. 2 shows an example of a memory management according to the invention. With the memory management according to the invention, several stacks are preferably initially created during an initialisation process. These stacks are a specialised form of singly-linked lists. FIG. 2 shows four such stacks, which are indicated with the reference numbers 6, 7, 8 and 9. Each of these stacks 6 to 9 comprises several memory objects of different sizes. For example, objects up to a size of 16 bytes can be stored in the first stack 6; objects up to a size of 32 bytes can be stored in the second stack 7; objects up to a size of 64 bytes can be stored in the third stack 8; and finally, objects up to a size of 128 bytes can be stored in the fourth stack 9. In the case of an occurrence of larger elements to be stored, stacks with larger memory objects can also be created, wherein the size of the individual memory objects is preferably doubled relative to the next respective stack. The subdivision of a stack of this kind into individual memory objects 10.i is shown in detail for the fourth stack 9. The fourth stack 9 consists of a series of memory objects 10.1, 10.2, 10.3, . . . , 10.k linked singly to one another. The last memory object 10.k of the fourth stack 9 is illustrated slightly offset in FIG. 2. For all stacks 6 to 9, access to the individual memory objects is possible only for the lowest memory objects of the stack 6 to 9 respectively, for example, with regard to stack 9, only for memory object 10.k.

Consequently, the last memory object 10.k of the fourth stack 9 in FIG. 2 can be used, for example, in the event of a request for memory. If the memory object 10.k becomes free again, because it is no longer needed by a thread, it will be returned accordingly to the end of the fourth stack 9.

FIG. 2 shows this schematically through a number of different threads 11, through which a memory request is given in each case. With the concrete exemplary embodiment, for example, a process in several threads 12, 13 and 14 requests memory volumes of the same size. The size of the memory requested results from the data to be stored. In the exemplary embodiment presented, the fourth stack 9 is selected, as soon as a memory requirement of more than 64 bytes up to a maximum size of 128 bytes is present. Now, if a memory volume, for example, of 75 bytes is required through the first thread 12, the stack from among the stacks 6 to 9, which contains a free memory object of a suitable size, is initially selected. In the exemplary embodiment presented, this is the fourth stack 9. Memory objects 10.i with a size of 128 bytes are provided here. Since the memory object 10.k is the last memory object in the fourth stack 9, a so-called “pop” operation is worked through on the basis of the memory request of the first thread 12, and accordingly, the memory object 10.k is made available to the thread 12.

A pop-routine of this kind is atomic or indivisible, that is to say, the memory object 10.k is removed from the fourth stack 9 for the thread 12 in a single processing stage. This atomic or indivisible operation, with which the memory object 10.k is assigned to the thread 12, prevents another thread, for example, thread 13, from gaining access to the same memory object 10.k at the same time. That is to say, as soon as a new processing stage can be implemented by the system, the processing with regard to the memory object 10.k is terminated and the 10.k^{th} memory object is no longer a component of the fourth stack 9. In the event of a further memory request through the thread 13, the last memory object of the fourth stack 9 at this time is therefore memory object 10.k-1. Here also, an atomic pop-operation is again implemented to transfer the memory object 10.k-1 to the thread 13.

Atomic operations of this kind presuppose corresponding hardware support and cannot be formulated directly in normal programming languages, but require the use of machine code. However, according to the invention, these hardware-implemented, so-called lock-free pop calls or lock-free push calls are not normally used for memory management. For this purpose, for example, a singly-linked list, in which memory objects can be retrieved or respectively returned only at one end of the created stack, is used instead of the doubly-linked lists as presented schematically in FIG. 1.

FIG. 2 also shows how, for a number of threads 15, each memory object is returned to the appropriate stack when it becomes free after a delete call from a thread. As shown for the memory object 10.k in FIG. 2, a header 10.i_{head}, in which the assignment to a given stack is coded, is present in each of the memory objects 10.i. For example, the assignment to the fourth stack 9 is contained in the header 10.k_{head}. Now, if a delete a function is called through a thread 16, to which the memory object 10.k has been assigned on the basis of a corresponding lock-free-pop operation, the memory object 10.k is returned by a corresponding, similarly-atomic lock-free-push operation. In this context, the memory object 10.k is appended to the last memory element 10.k-1 associated with the fourth stack 9. Accordingly, the sequence of the memory objects 10.i in the fourth stack 9 is modified dependent upon the sequence, in which different threads 16, 17, 18, return the memory objects 10.i.

It is important that these so-called lock-free-pop-calls and lock-free-push-calls are atomic and can therefore be processed extremely quickly. In this context, the speed advantage is based substantially upon the fact that the use of an operating-system operation, such as mutex, is not necessary, in order to exclude further threads from a simultaneous access to a given memory object. An exclusion of this kind with regard to the simultaneous access by further threads is not necessary because of the atomic nature of the pop and push calls. In particular, with an actually-simultaneous access to the memory management (so-called contention case), the operating system need not implement a thread change, which requires disproportionately more computational time by comparison with the memory operation itself.

With a memory management of this kind for memories in stacks and access by means of lock-free-pop and lock-free-push calls, some of the available memory volume is inevitably wasted. This waste results from the size of the individual stacks or respectively their memory objects, which is adapted in a non-ideal manner. However, if a given size structure of the data to be stored is known, the distribution of sizes of memory-object in the individual stacks 6 to 9 can be adapted to this.

According to one particularly-preferred form of the memory management according to the invention, the stacks 6 to 9 required for the process are merely initialised, but, at this time, at the beginning of a process, for example, after a program start, do not yet contain any memory objects 10.i. Now, if a memory object of a given size is required for the first time, for example, a memory object in the third stack 8 for a 50-byte element to be stored, this first memory request is processed via the slower system-memory management, and the memory object is made available from there. In the example explained above with regard to doubly-linked lists as a system-memory management, simultaneous access is prevented by a slow mutex operation. However, the memory object made available in this manner to a first thread is not returned after a delete call via the slower system-memory management, but is stored via a lock-free-push operation in a corresponding stack, in the described exemplary embodiment, in the third stack 8. For the next call of a memory object of this size, access to this memory object can be gained through a very fast lock-free-pop operation.

This procedure has the advantage that a fixed number of memory objects need not be assigned to the individual stacks 6, 7, 8 and 9 globally at the beginning of the process. On the contrary, the memory requirement can be adapted dynamically to the current process or to its threads. For example, if a process is running in the background with a few subsidiary threads and has only a small demand for memory objects, considerable resources can be saved with a procedure of this kind.

The method is presented once again in FIG. 3. In stage 19, a program is initially started, for example, on a computer and a process is therefore generated. At the start of the process, several stacks 6 to 9 are initialised. The initialisation of the stacks 6-9 is presented in stage 20. In the exemplary embodiment presented in FIG. 3, only a few stacks 6-9 are initially created, but these are not filled with a given, pre-defined number of memory objects. In the event of a memory request from a thread occurring in procedural stage 21, a corresponding stack is first selected on the basis of the object size specified by the thread.

For example, if a 20-byte memory object is required, the second stack 7 is selected in the stack selection shown in FIG. 2. Following this, an interrogation is implemented in stage 23, the atomic pop-operation. One component of this indivisible operation is an interrogation 26 regarding whether a memory object is available in the second stack 7. If stack 7 with a size of 32 bytes per memory object is merely initialised, but still contains no available memory object, a zero vector (“NULL”) is returned and a 32-byte memory object is made available via a system-call in stage 24 via the slower system-memory management. However, the size of the memory object made available in this context is not directly specified by the thread in stage 21, but rather via the selection of a given object size in stage 22 taking into consideration the initialised stack.

In the exemplary embodiment described, the memory request is therefore altered in such a manner that a memory object with the size 32 bytes is requested. In the example of the system-memory management by means of doubly-linked lists, a mutex operation would be started via the operating system in order to prevent simultaneous access to this memory object during retrieval by the thread.

By contrast, if the memory object required is a memory object, which has already been returned during the course of the process, this is already present in the second stack 7. The interrogation in stage 26 should therefore be answered with “yes”, and a memory object is delivered directly. For the sake of completeness, in the further course of the method, the return of the memory object on the basis of a delete call is presented both for a memory object made available by means of lock-free-pop-call and also via system-memory management. The process following a delete call of the thread is identical for both situations. That is to say, no consideration is given here to the manner, in which the memory object was made available. In FIG. 3, this is presented schematically through the two parallel routes, reference numbers on the right-hand side are shown with a dash.

Initially, a delete call is started through a thread. The corresponding memory object is assigned to a given stack by evaluating the information in the header of the memory object. In the exemplary embodiment described, the memory object of size 32 bytes is therefore assigned to the second stack 7. In both cases, the memory object is returned to the second stack 7 via a lock-free-push operation 29 or respectively 29′. The last procedural stage 30 indicates that the memory object of the second stack returned in this manner is accordingly available for a subsequent call. As already explained, this next call can then be made available to a thread through a lock-free-pop operation.

As has already been described, a reduction in the waste of memory can be achieved in the initialisation of stacks 6 to 9 by preparing frequency distributions for requested object sizes. This can also be established for individual processes during the running of the various processes. If a process of this kind with its subsidiary threads is re-started, access will be gained to the previously-determined frequency distribution from the preceding process, in order to allow an adapted size distribution of the stacks 6 to 9. The system can be designed as an intelligent system, that is to say, with each new run, the information already obtained about size distributions of the memory demand can be updated, and the respectively-updated data can be used with the each new call of the process.

The invention is not restricted to the exemplary embodiment presented. On the contrary, any required combination of the individual features explained above is possible.

1. Method for memory management comprising the following procedural stages:
Creation of at least one stack for memory objects;
Execution of a request for a memory object from a stack by means of an atomic operation; and
Return of a memory object to the stack by means of an atomic operation wherein
after an initialisation of the stacks, no memory objects initially exist in the stacks, and in each case, in the event of a first request for memory-volume, a memory object is requested via a system-memory management, and this memory object is assigned to a stack when it is returned, wherein
before the request for the memory object via the system-memory management, the size of the memory object is established through the size of the initialised stack and of the current request for memory-volume.

2. Method according to claim 1, wherein
several stacks are created respectively for different sizes of memory object.

3. Method according to claim 1 or 2, wherein
before the retrieval of a memory object, the stack with the next largest size of memory object respectively by comparison with a memory request is selected.

4. Method according to claim 1, wherein
in order to establish the sizes of the memory objects in the stacks, a frequency distribution of memory-object sizes is updated during a process, and at the time of a new execution of the process, the respectively-updated frequency distribution is used as the basis for the initialisation of the stack.

5. Computer software product with program-code means stored on a machine-readable carrier, in order to implement all the stages according to any one of claims 1, 2 or 4, when the software is run on a computer or a digital signal processor of a telecommunications device.

6. Computer software with program-code means for the implementation of all of the stages according to any one of claims 1, 2 or 4, when the software is run on a computer or a digital signal processor of a telecommunications device.

7. Computer software with program-code means for the implementation of all of the stages according to claim 3, when the software is run on a computer or a digital signal processor of a telecommunications device.

8. Computer software product with program-code means stored on a machine-readable carrier, in order to implement all the stages according to claim 3, when the software is run on a computer or a digital signal processor of a telecommunications device.
